(19) United States
(12) Patent Application Publication
(10) Pub. No.: US 2003/0209572 A1
(43) Pub. Date: Nov. 13, 2003

(54) Integrated measuring cap for liquids

(76) Inventor: David Vaughn Myers, San Juan, PR (US)

Correspondence Address: DAVID V. MYERS, 252 FORTALEZA, P.O. BOX 9023145, SAN JUAN, PR, 00902, US

(21) Appl. No.: 10/141,888

(22) Filed: May 9, 2002

(51) Int. Cl. G01F 11/28

(52) U.S. Cl. 222/452

(57) ABSTRACT

A dispensing container is described in which a measuring cap, for The contents of a liquid container, is rotatably mounted on the adapted bottle neck of the container. Particularly, the bottle neck is partially closed, having two diametrically opposed openings. A container interior partition separates the two bottle neck openings (the fill opening and the dispensing opening), and communicates with the dispensing spout being an integral part of the container. The measuring cap, an annular wall with top wall and base wall, snaps securely on the bottle neck. The base wall of the measuring cap is closed except for one opening, the size and shape being equal to each of the two openings of the bottle neck. Rotary movement of the measuring cap allows the opening of the measuring cap to align with either bottle neck opening. With the container in a pouring attitude, and the single opening of the bottle neck in alignment with the fill opening of the measuring cap, a quantity of liquid is admitted into the measuring cap whose dimensions determine the quantity of liquid desired. Further rotation allows the desired quantity to be isolated within the measuring cap, while as rotation continues, the opening of the measuring cap aligns with the dispensing opening of the bottle neck, allowing the isolated liquid, now measured, to exit, directed by the interior partition, through the dispensing spout.

### BACKGROUND OF INVENTION

The present invention relates to measuring caps and dispenser caps for bottles and similar containers and particularly to a measuring cap which dispenses a premeasured amount of liquid such as detergents, bleaches and other fluids.

Many household products come in liquid forms such as laundry detergents, bleaches, etc. Most such products indicate a certain quantity of the fluid to be used. Generally, this measured quantity is accomplished by use of a separate measuring device. Currently, liquid detergent dispensers utilize the cap which is designed upon removal to be inverted and used for measuring.

The present invention incorporates a measuring cap as an integral part of the container, therefore eliminating the need for an external measuring cup. While incorporating a measuring function within a container/cap construction for measuring a predetermined amount of the contents of a container is not new (examples: U.S. Pat. Nos. 3,129,859; 3,402,860; 5,020,699; 5,246,148; 5,489,049; and 6,068,165), the present invention improves and simplifies the structures for accomplishing the desired results.

### BRIEF SUMMARY OF THE INVENTION

The object of the invention is to provide an improved measuring, dispensing assembly to be used with plastic containers to dispense a predetermined quantity of liquid.

To accomplish this purpose, a measuring cap assembly constructed in accordance with the present invention is used with a plastic container having a body portion for holding liquid contents. The measuring cap assembly is rotatably mounted on the adapted bottle neck of the container by introduction of the annular rib of the bottle neck within the annular groove of the measuring cap. The adapted bottle neck of the container has a top wall with two diametrically opposed openings of equal size and shape, comprising slightly less than two quadrants of the area of the top wall of the bottle neck, and functioning as the fill opening and dispensing opening. An interior partition laterally separates the two openings of the bottle neck and projects in an oblique line to communicate with the dispensing spout. The measuring cap, an annular wall extending upward from the bottle neck with a top wall and base wall, is constructed with a single opening in the base wall equal in size and shape to each of the openings of the bottle neck top wall, and comprising slightly less than one quadrant of the area of the measuring cap base wall.

With the container in a pouring attitude, and the measuring cap opening aligned with the fill opening of the bottle neck, liquid enters the hollow interior of the measuring cap, while the remaining closed area of the measuring cap covers the dispensing opening of the bottle neck. Being of clear plastic, completion of the fill function of the measuring cap is easily discernable. The single stop tab located on the peripheral skirt of the measuring cap and positioned perpendicularly to the single opening of the measuring cap, is intercepted, during rotary movement, by the two stop tabs located on the annular wall of the bottle neck and strategically located at the fill and dispensing openings. The interaction of these stop tabs accommodates access to the fill and dispensing functions during operation. With the hollow interior of the measuring cap full, further rotary movement, unaligns the measuring cap opening with the fill opening of the bottle neck, thereby isolating the liquid within of the measuring cap. Continued rotary movement aligns the measuring cap opening with the dispensing opening of the bottle neck, while the remaining closed area of the measuring cap covers the fill opening of the bottle neck, which allows the isolated liquid to exit, directed by the interior partition, through the dispensing spout.

This improved construction of the measuring cap assembly, functioning in conjunction with the adapted container and bottle neck allows for dispensing of a measured amount of the liquid contents of the container without the necessity of removing the closure member as has previously been the case and with drain-back closure assemblies currently in use.

In addition, contrary to previous attempts at measuring dispenser assemblies, in which the dispenser closure assembly is fixedly mounted on the open end of the container, and therefore functions as an measuring dispensing assembly unit operating independent of the container, which serves only for holding the liquid contents. The present invention accomplishes the measuring and dispensing functions only as an integrated unit of container and measuring cap. The unique measuring cap, the adapted bottle neck, the integrated dispensing spout and interior partition communicating with the dispensing spout of the container also differentiates the present patent from prior art.

In its preferred construction, the adapted bottle neck has an annular rib received by the annular groove of the measuring cap, allowing for a rotatably mounted measuring cap unit to be joined in a liquid sealed relationship.

In the preferred construction, the stop tab of the measuring cap interacts with two strategically placed stop tabs of the adapted bottle neck to halt rotary movement and align the openings of the measuring cap and bottle neck to initiate either fill or dispensing functions.

In the preferred construction, an interior partition laterally divides the openings of fill and dispensing functions, communicating with the dispensing spout which is an integral part of the container.

In the preferred construction, the dispensing spout being an elliptical wall extending from the frontal wall of the container and communicating with the dispensing opening of the bottle neck by the interior partition. The outermost opening of the dispensing spout having an elliptical groove for engagement of the dispensing spout closure.

In the preferred construction, the dispensing spout closure, equal in size and shape to the outermost opening of the dispensing spout, having an elliptical rib for engagement with the elliptical groove of the dispensing spout. A tab extension facilitates removal of the dispensing spout closure. The dispensing spout closure is employed for shipping purposes only, and discarded when the dispensing measuring assembly is in use.

### BRIEF DESCRIPTION OF SEVERAL VIEWS OF THE DRAWINGS

FIG. 1 is a perspective view of the dispensing measuring assembly which includes the plastic container body and mounted measuring cap.

FIG. 2 is a perspective view of the individual parts which comprise the dispensing measuring assembly; the plastic container, the measuring cap, and the dispensing spout closure unit.

FIG. 3 is a sectional view of the dispensing measuring assembly in a pouring attitude, illustrating the fill function of the container package.

FIG. 4 is a sectional view of the dispensing measuring assembly in a pouring attitude of lesser degree than FIG. 3, illustrating the dispensing function of the container package.

### DETAILED DESCRIPTION OF THE INVENTION

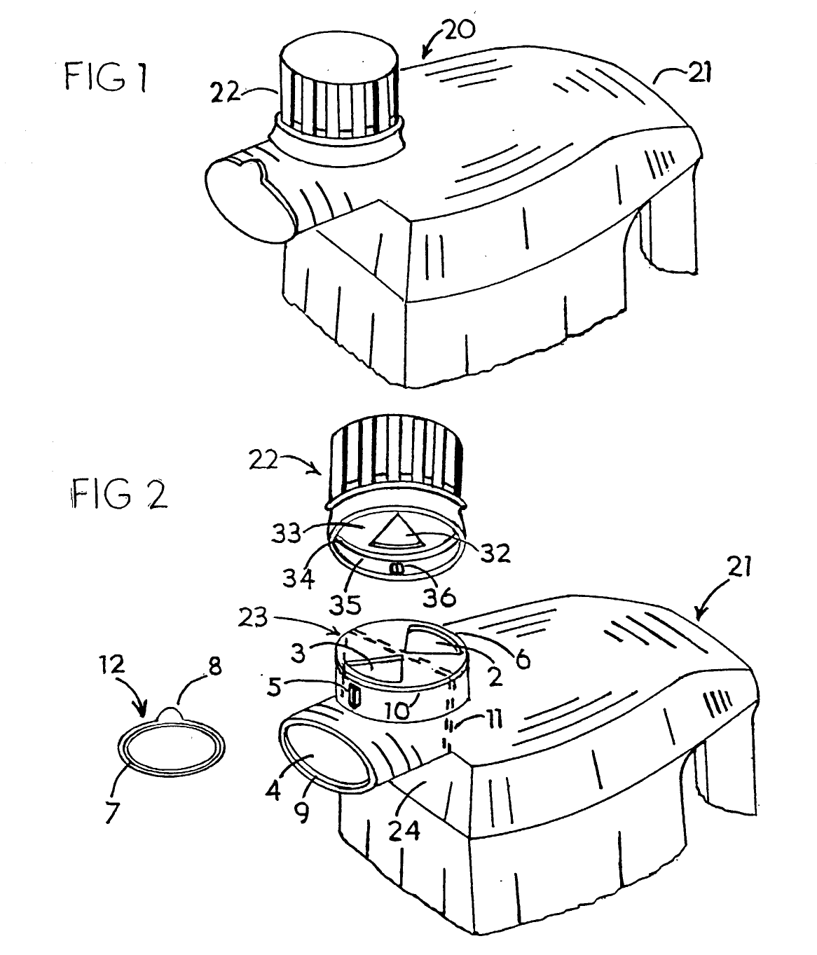

With reference to FIG. 1 of the drawings, a dispensing measuring assembly is generally indicated by 20 and includes a plastic container 21 on which is mounted a measuring cap 22 that is constructed in accordance with the present invention.

With reference to FIG. 2, the plastic container 21 holds the liquid contents such as detergents, bleach, etc. And has an adapted bottle neck 23 on which the measuring cap 22 is rotatably mounted. The mounting of measuring cap 22 is securely accomplished by the engagement of the annular rib 10 of the bottle neck 23 within the annular groove 34 of the measuring cap 22, allowing for rotary movement of the measuring cap on the bottle neck. A snap action occurs as the annular groove 34 receives annular rib 10 and cooperates with the annular walls of the members in providing a fluid tight seal while still permitting rotation. The bottle neck top wall, having two diametrically opposed openings, 2 and 3, function respectively as fill opening and dispensing opening when interacting with the single opening 32 of the measuring cap 22. The single opening 32 of the measuring cap equals slightly less than one quadrant of the total base wall area, the remaining area 33, being closed. Perpendicular placement of stop tabs 5 and 6 (not visible) on the annular wall of bottle neck 23 intercept stop tab 36 of the measuring cap peripheral skirt 35 during rotary movement for initiating either the fill function or dispensing function during operation. Interior partition 11, which laterally separates bottle neck openings 2 and 3, communicates with dispensing spout 4 which extends from container frontal wall 24. Elliptical groove 9 of the dispensing spout 4 receives elliptical rib 7 of the dispensing spout closure unit 12, while the tab extension 8 facilitates removal of the dispensing spout closure unit 12.

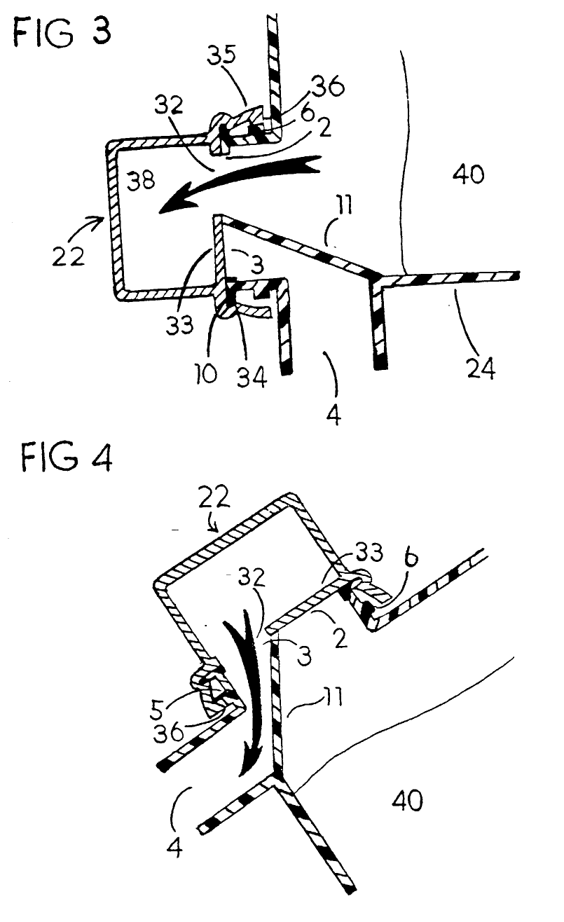

Referring to FIG. 3, in a pouring attitude, opening 32 of the measuring cap 22, when aligned by rotary movement with bottle neck opening 2, allows for entry of liquid 40 into the hollow interior 38 of the measuring cap. The remaining closed area 33 of the measuring cap base wall covers dispensing opening 3 of the bottle neck. Partition 11, an interior division which laterally separates fill opening 2 from dispensing opening 3, projects in an oblique line toward container frontal wall 24 and communicates with dispensing spout 4. Partition 11 directs the flow of liquid for both fill and dispensing functions. The measuring cap 22, being made of clear plastic, makes completion of the fill function easily perceived. The engagement of bottle neck annular rib 10 with measuring cap annular groove 34, allows for the rotation of measuring cap 22 in a liquid sealed relationship. Measuring cap stop tab 36, located on the slightly flared peripheral skirt 35, is intercepted by stop tab 6 of the bottle neck to temporarily stop rotation of the measuring cap, for initiating the fill function. Continued rotation of the measuring cap allows stop tab 36 of the measuring cap to disengage from stop tab 6 of the bottle neck, while closed area 33 of the measuring cap base wall covers fill opening 2 of the bottle neck and isolates the liquid with in the hollow interior 38 of the measuring cap.

Referring to FIG. 4, continued rotary movement creates the interaction of stop tab 5 of the bottle neck with stop tab 36 of the measuring cap 22, preventing further rotation of the measuring cap while aligning the measuring cap opening 32 with dispensing opening 3 of the bottle neck. Coinciding with the alignment of measuring cap opening 32, with dispensing opening 3, is the covering of fill opening 2 by measuring cap closed area 33. The isolated liquid within the measuring cap 22 exits through dispensing opening 3 of the bottle neck. The flow of liquid 40 is directed by partition 11 through dispensing spout 4.

Referring to FIG. 2, secured sealing of the dispensing measuring assembly for shipment is accomplished with the dispensing closure unit 12 with elliptical rib 7 being received within elliptical groove 9. Tab extension 8 assists in removal of the dispensing closure unit 12, which is discarded before the dispensing measuring assembly is used.

While the best methods for carrying out the invention has been described, those familiar to the art to which this invention relates, will recognize various alternating designs and embodiments for practicing the invention as defined by the claims.

What is claimed is:

1) A dispensing measuring assembly for measuring amounts of contents from a container having a body portion for holding liquid contents, an adapted container, and a measuring cap, functioning in unison for dispensing a premeasured quantity of liquid. The measuring cap is constructed to be rotatably mounted on the adapted bottle neck of the container. The measuring cap comprised of annular wall projecting upward from the bottle neck of the container with a top wall and base wall defining the hollow interior of the measuring cap. An opening in the base wall of the measuring cap equal in size to slightly less than one quadrant of the total area of the measuring cap base wall, and equal in size and shape to each of the two openings, fill opening and dispensing opening, of the bottle neck top wall. With the container in a pouring attitude, the alignment of the single measuring cap opening with the fill opening of the bottle neck top wall, allows the measuring cap to fill with the desired quantity of liquid, while the remaining closed area of the measuring cap base wall covers the dispensing opening of the bottle neck. With the measuring cap constructed of clear plastic, completion of the fill function of the measuring cap is easily perceived. Further rotation of the measuring cap isolates the desired quantity of liquid, while with continued rotation, the opening of the measuring cap aligns with the dispensing opening of the bottle neck as the remaining closed area of the measuring cap base wall covers the fill opening of the bottle neck. This allows the desired measured quantity of liquid to exit the dispensing opening, and directed by the interior partition, the dispensing spout.

2) A dispensing measuring assembly having a measuring cap with an annular wall constructed to include an annular groove below the measuring cap base wall to receive the annular rib of the bottle neck, allowing for rotary movement of the measuring cap in a liquid sealed relationship.

3) A slightly flared peripheral skirt extending below the annular groove of the measuring cap, facilitating the mounting of the measuring cap on the adapted bottle neck, and allowing for placement of a single stop tab, positioned perpendicularly below the single opening of the measuring cap, which interacts with the two diametrically opposed stop tabs located on the annular wall of the bottle neck.

4) A dispensing measuring assembly having a bottle neck adapted for engaging the measuring cap. The bottle neck is comprised of an annular wall, with a top wall, projecting upward from the container. The top wall of the bottle neck having two diametrically opposed openings, together equalling slightly less than two quadrants of the total area of the bottle neck top wall. Individually, each opening of the bottle neck top wall is equal in size and shape to the single opening of the measuring cap. The furthermost opening from the dispensing spout functions as the fill opening for allowing liquid to enter from the container and into the measuring cap, while the opening closest to the dispensing spout functions as the dispensing opening for allowing liquid to exit the measuring cap, being directed by the interior partition, through the dispensing spout.

5) A dispensing measuring assembly having a bottle neck with annular rib which is received within the annular groove of the measuring cap. The engagement of the bottle neck annular rib within the annular groove of the measuring cap allows for rotary movement of the measuring cap, in a liquid sealed relationship.

6) A dispensing measuring assembly having two diametrically opposed stop tabs on the exterior of the annular wall of the bottle neck and positioned below and perpendicular to the fill opening and dispensing opening of the bottle neck top wall. These stop tabs, during rotation of the measuring cap, work in conjunction with the single stop tab of the measuring cap, to temporarily stop rotation of the measuring cap at either fill function or dispensing function. Continued rotary movement of the measuring cap is stopped by the opposing stop tab of the bottleneck annular wall, which initiates either opposing function, filling or dispensing.

7) A dispensing measuring assembly having a partition, internally located, dividing laterally the two openings of the bottle neck top wall, and projecting in an oblique line toward the frontal wall of the container and communicating with the integrated dispensing spout.

8) A dispensing measuring assembly with a dispensing spout comprised of an elliptical wall extending outward from the frontal wall of the container. An internal partition, which separates the fill opening and the dispensing opening of the bottle neck, projects in an oblique line toward the frontal wall of the container and communicates with the integrated dispensing spout. The outermost opening of the dispensing spout having an elliptical groove for engaging the elliptical rib of the dispensing spout closure. Even though the configuration of the dispensing spout may vary, the mechanism for dispensing remains constant.

9) A dispensing measuring assembly having a dispensing spout closure, the size and shape of the outermost opening of the dispensing spout. The dispensing spout closure includes an elliptical rib received by the elliptical groove of the dispensing spout. A tab extension facilitates removal of the dispensing spout closure. The dispensing spout closure is utilized for shipping purposes only, and is discarded once the dispensing measuring assembly is being used.
